(19) United States
(12) Patent Application Publication
(10) Pub. No.: US 2017/0102498 A1
(43) Pub. Date: Apr. 13, 2017

(54) METHOD FOR MANUFACTURING GLASS LIGHT GUIDE PLATE HAVING HIGH TRANSMISSION EFFICIENCY

(71) Applicant: CHENFENG OPTRONICS CORPORATION, TAICHUNG (TW)

(72) Inventors: CHING-FANG WONG, TAICHUNG (TW); YU-WEI LIU, TAICHUNG (TW)

(21) Appl. No.: 14/879,643

(22) Filed: Oct. 9, 2015

(51) Int. Cl. F21V 8/00; C03B 23/02

(52) U.S. Cl. CPC G02B 6/0065; G02B 6/002; G02B 6/0043; G02B 6/0061; C03B 23/02; C03B 33/02

(57) ABSTRACT

A method for manufacturing a glass light guide plate having high transmission efficiency is provided. A glass plate is cut and formed using a cutter machine. The glass plate includes a first flat surface and a second flat surface that are opposite and parallel to each other, and a light incident surface perpendicular and connected to the first flat surface and the second flat surface. The light incident surface is heated and extruded using a thermoplastic machine to deform the light incident surface to form a light guide portion. The light guide portion includes a light guide surface perpendicular to the first flat surface and the second flat surface, and has an area greater than an area of the light incident surface. When a light enters via the light guide surface, the amount of light irradiating corners of the light guide surface is reduced.

### FIELD OF THE INVENTION

The present invention relates to a method for manufacturing a light guide plate, and particularly to a method for manufacturing a light guide plate having high transmission efficiency.

### BACKGROUND OF THE INVENTION

One main function of a light guide plate is guiding propagation directions of light beams using principles of total reflection and scattering. After entering via a light incident surface of a light guide plate, a beam undergoes total reflection and scattering in the light guide plate. The light beam then exits in a uniform manner from a light emission surface of the light guide plate, hence allowing a point light source or a line light source to become a plane light source that can be extensively applied in fields of display and illumination devices.

The U.S. Pat. No. 7,478,942, “Light Guide Plate with Light Reflection Pattern” disclosed a light guide plate. The light guide plate of the disclosure includes a light incident surface that receives a light beam, a first surface, a second surface, and a plurality of light reflection patterns disposed at the first surface. These light reflection patterns reflect the light beam to cause the light beam to emit toward the second surface. The light guide plate is generally made of a plastic material. With the progress in glass manufacturing technologies, glass light guide plates have been currently developed by associated manufacturers. However, during the course of processing glass into a light guide plate having an appropriate size, glass is cut, and extremely sharp corners that easily cut operating staff during processes of moving or manufacturing can be formed. Therefore, chemical or physical grinding processes are performed on the corners to round these corners.

However, referring to FIG. 1, a rounded corner 1 increases the possibility of reflecting a light 2, such that the light entering a glass light guide plate is decreased and light guide efficiency is reduced. Therefore, it is a goal of associated industrialists to reduce the possibility of reflection of a light, increase the light entering the glass light guide plate and enhance light guide efficiency.

### SUMMARY OF THE INVENTION

It is a primary object of the present invention to solve issues of decreased light entering a glass light guide plate and reduced light guide efficiency caused by a rounded corner liable to reflecting light.

To achieve the above object, the present invention provides a method for manufacturing a glass light guide plate having high transmission efficiency. The method includes following steps.

In step S1, a glass plate is cut and formed using a cutter machine. The glass plate includes a first flat surface and a second flat surface that are opposite and parallel to each other, and a light incident surface perpendicular and connected to the first flat surface and the second flat surface.

In step S2, the light incident surface of the glass plate is heated and extruded by a thermoplastic machine to deform the light incident surface to form a light guide portion. The light guide portion includes a light guide surface perpendicular to the first flat surface and the second flat surface, and has an area greater than an area of the light incident surface.

In conclusion, the present invention provides following features.

1. The light guide surface is formed by heating and extruding the light incident surface of the glass plate. As the area of the light guide surface is greater than the area of the light incident surface, incident light is less likely to irradiate upon corners of the light guide surface, thereby reducing the possibility of reflection of the light and enhancing light guide efficiency.

2. With the area of the light guide plate being greater than the area of the light incident surface, the incident amount of light is increased to enhance light guide efficiency.

3. Through the method for manufacturing the light guide portion by heating and extrusion using the thermoplastic machine, the light guide portion is formed as an integral on the glass plate, thereby preventing an issue of brightness loss due light reflection caused by additionally manufactured light guide elements.

### BRIEF DESCRIPTION OF THE DRAWINGS

FIG. 1 is a partial schematic diagram of an incident light entering a conventional light guide plate;

FIG. 2 is a schematic diagram of a manufacturing process according to a first embodiment of the present invention;

FIG. 3A to FIG. 3E are consecutive schematic diagrams of manufacturing a structure according to the first embodiment of the present invention;

FIG. 4 is a top structural schematic diagram according to the first embodiment of the present invention;

FIG. 5 is a side structural schematic diagram according to a second embodiment of the present invention;

FIG. 6 is a partial schematic diagram of an incident light of the present invention;

FIG. 7 is a schematic diagram of an application of the present invention; and

FIG. 8 is a schematic diagram of a manufacturing process according a third embodiment of the present invention.

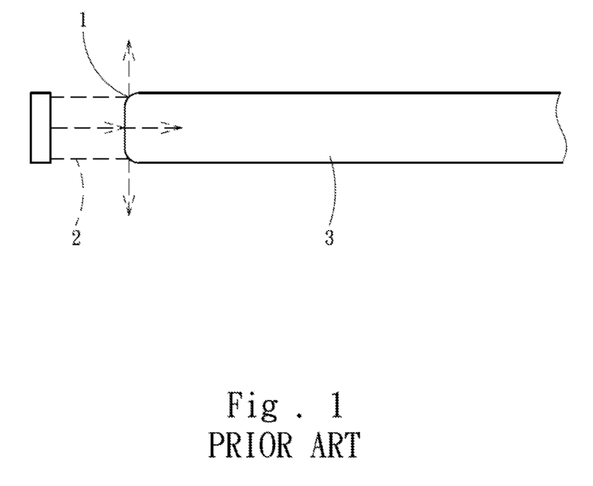

### DETAILED DESCRIPTION OF THE PREFERRED EMBODIMENTS

Details and technical contents of the present invention are given with the accompanying drawings below.

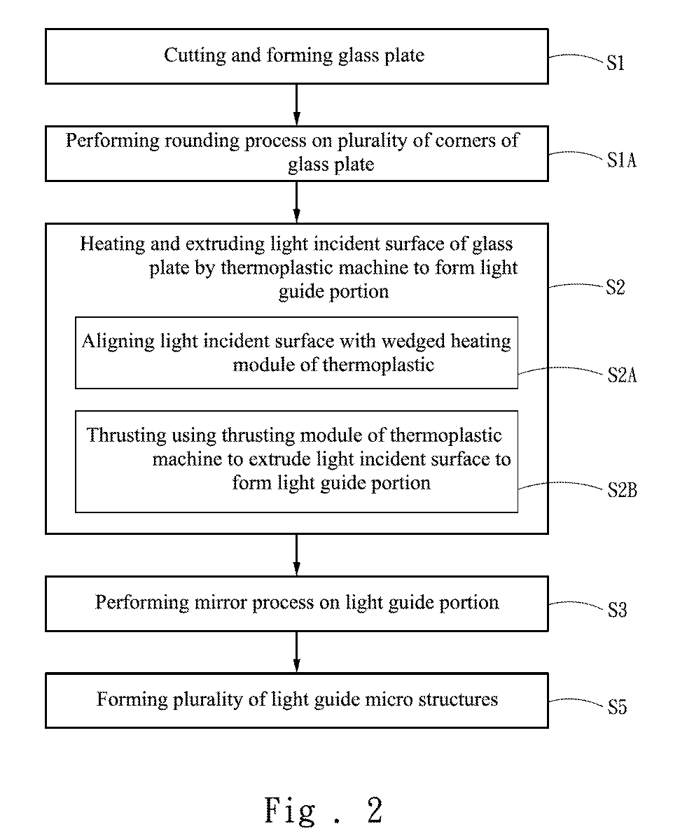

FIG. 2 to FIG. 6 show a schematic diagram of a manufacturing process, consecutive schematic diagrams of manufacturing a structure, and a top structural schematic diagram according to a first embodiment of the present invention, and a side structural schematic diagram and a partial schematic diagram of an incident light according to a second embodiment of the present invention. Referring to FIG. 2 to FIG. 6, a method for manufacturing a glass light guide plate having high transmission efficiency of the present invention includes following steps.

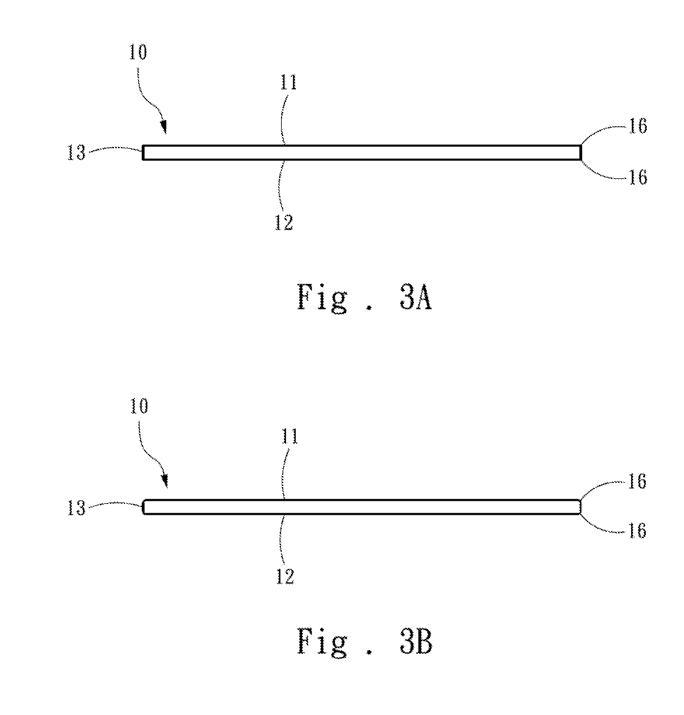

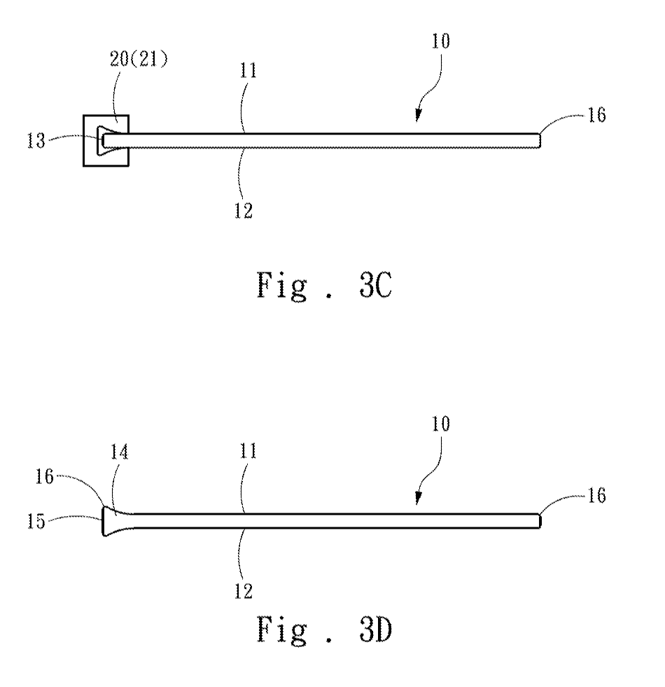

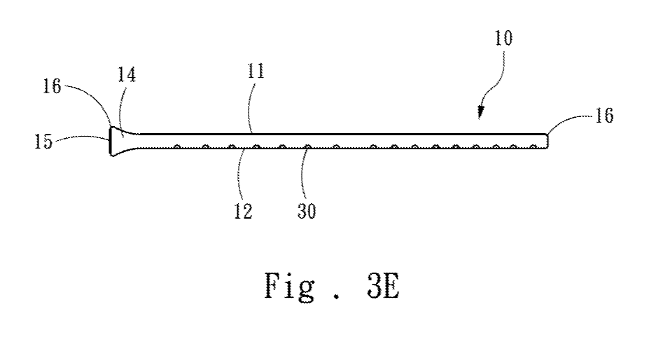

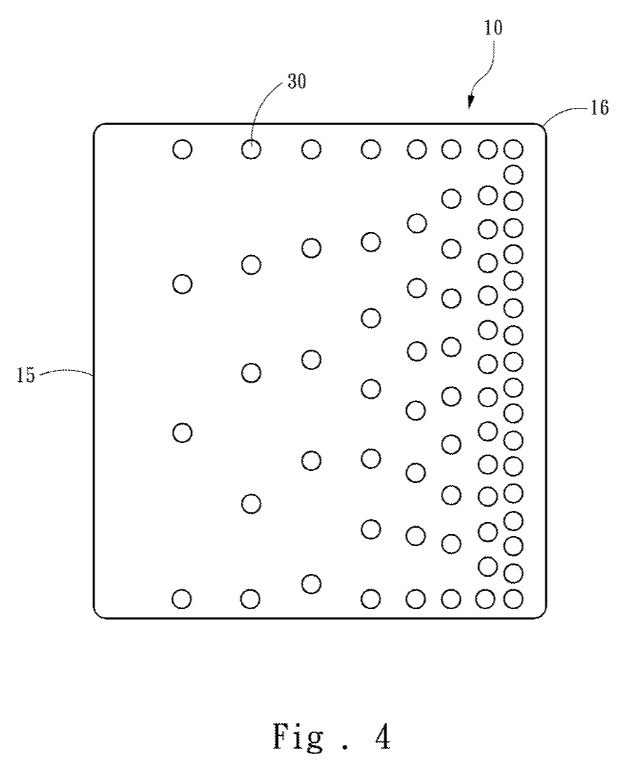

In step S1, a glass plate 10 is cut and formed using a cutter machine (not shown). The glass plate 10 includes a first flat surface 11 and a second flat surface 12 that are opposite and parallel to each other, and a light incident surface 13 perpendicular and connected to the first flat surface 11 and the second flat surface 12. As shown in FIG. 3, the first flat surface 11 is located on the second flat surface 12. In the embodiment, the method further includes following steps.

In step S1A, using a computer numerically-controlled (CNC) tool machine or a process such as chemical grinding, a rounding process is performed on a plurality of corners 16 of the glass plate 10, as shown in FIG. 3B. The rounding process prevents these overly sharp corners 16 from hurting operating staff or breaking during processes of moving or manufacturing, and thus from increasing costs. Further, step S2 may be directly performed, through which the formation of sharp corners can be directly reduced by a gathering effect of molecules of the glass in a molten state.

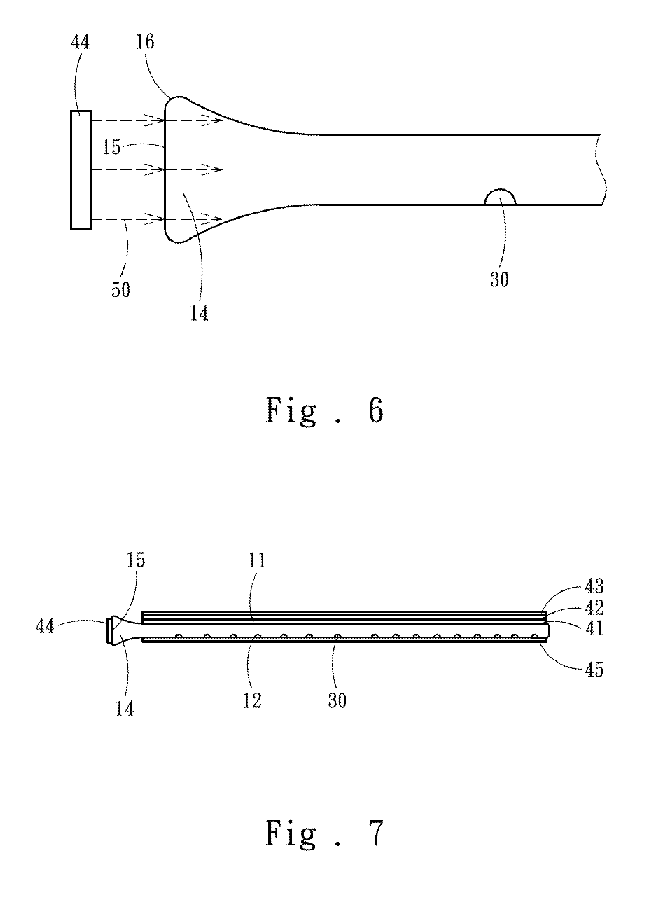

In step S2, as shown in FIG. 3C and FIG. 3D, the light incident surface 13 of the glass plate 10 is heated and extruded using a thermoplastic machine 20 to deform the light incident surface 13 to form a light guide portion 14. The light guide portion 14 includes a light guide surface 15 perpendicular to the first flat surface 11 and the second flat surface 12, and has an area greater than an area of the light incident surface 13. Referring to FIG. 6, when a light source 44 emits a light 50 toward the light guide surface 15, due to the heating and extrusion performed by the thermoplastic machine 20, the light guide surface 15 is made to be greater than the light incident surface 13, such that the incident amount of the light 50 is increased. Further, the incident light 50 is less likely to irradiate upon the corners 16 of the light guide surface 15, so that the possibility of reflection of the light 50 is reduced to increase light guide efficiency. Moreover, by manufacturing the light guide portion 14 in a formed integral using the thermoplastic machine 20, the light 50 is prevented from generating additional refraction due to additionally manufactured light guide elements to further eliminate the issue of brightness loss. In the embodiment, more specifically, step S2 includes following steps.

In step S2A, the light incident surface 13 of the glass plate 10 is aligned and placed into a wedged heating module 21 of the thermoplastic machine 20. The wedged heating module 21 heats the light incident surface 13 of the glass plate 10 to cause the light incident surface 13 to become a molten state and plastic.

In step S2B, the wedged heating module 21 is thrust using a thrust module (not shown) of the thermoplastic machine 20 to extrude the light incident surface 13 of the glass plate 10 to further cause the plastic light incident surface 13 to form the light guide portion 14. To correspond to the shape of the wedged heating module 21, the light guide portion 14 also has a wedged shaped.

In step S3, a mirror process is performed on the light guide surface 15. For example, a polishing process is performed on the light guide surface 15, such that a surface roughness (Ra) of the light guide surface 15 is smaller than 0.2 μm to reduce the level of scattering of the light 50.

In step S5, as shown in FIG. 3E, a plurality of light guide micro structures 30 are formed on the second flat surface 12. These light guide micro structures 30 reflect the light 50 to the first flat surface 11, and the light 50 then emits from the first flat surface 11.

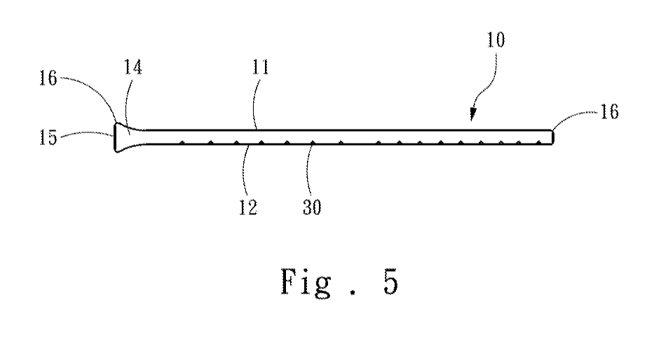

In the first embodiment of the present invention, the shape of these light guide micro structures 30 is semi-spherical. As shown in FIG. 4, a distribution density of the light guide micro structures 30 adjacent to the light guide portion 14 is lower than a distribution density of the light guide micro structures 30 away from the light guide portion 14. As such, the light 50 is allowed to uniformly emit from the first flat surface 11. However, the distribution density of the light guide micro structures 30 can be modified according to user requirements, and is not limited to the above example. FIG. 5 shows a second embodiment of the present invention. In the embodiment, the shape of the light guide micro structures 30 is pyramidal. Similarly, the shape of the light guide micro structures 30 can be modified according to user requirements.

FIG. 7 shows a schematic diagram of the present invention applied to a backlight module. Referring to FIG. 7, on the first flat surface 11, a lower diffusion sheet 41, a brightness reinforcing sheet 42 and an upper diffusion sheet 43 are sequentially disposed. A reflecting layer 45 is disposed on the second flat surface 12. A light source 44 that emits a light 50 is disposed at the light guide surface 15. The light 50 enters the glass plate 10 via the light guide surface 15. When the light 50 irradiate upon the light guide micro structures 30, the light 50 is reflected and emitted via the first flat surface 11, and passes through the lower diffusion sheet 41, the brightness reinforcing sheet 42 and the upper diffusion sheet 43 to cause the emitted light to be more uniform. When the light 50 is accidentally emitted from the second flat surface 12, the light 50 is again reflected by the reflecting layer 45 back to the glass plate 10. As the glass plate 10 is heat resistant, the light source 44 may be adhered on the light guide surface 15 without incurring an issue of becoming melted due to heat. Further, the embodiment is implemented in an application illustrated using an example of a backlight module. It should be noted that, the embodiment may also be applied to fields requiring light guide plates, and is not limited to the above example.

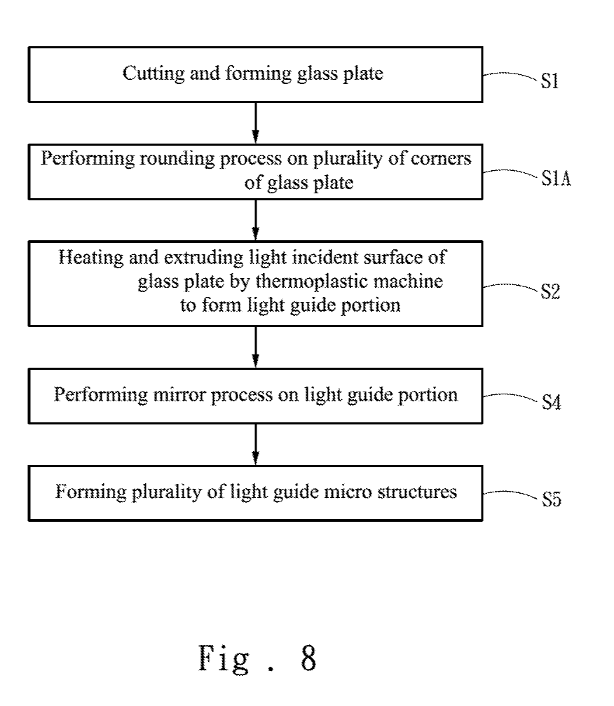

FIG. 8 shows a schematic diagram of a manufacturing process according to a third embodiment of the present invention. The present invention further provides a method for manufacturing a glass light guide plate having high transmission efficiency. The method includes following steps.

In step S1, a glass plate 10 is cut and formed using a cutter machine (not shown). The glass plate 10 includes a first flat surface 11 and a second flat surface 12 that are opposite and parallel to each other, and a light incident surface 13 perpendicular and connected to the first flat surface 11 and the second flat surface 12. The first flat surface 11 is located on the second flat surface 12.

In step S1A, using a CNC tool machine or a process such as chemical grinding, a rounding process is performed on a plurality of corners 16 of the glass plate 10. The rounding process prevents these overly sharp corners 16 from hurting operating staff or breaking during processes of moving or manufacturing, and thus from increasing costs.

In step S2, the light incident surface 13 of the glass plate 10 is heated and extruded using a thermoplastic machine 20 to deform the light incident surface 13 to form a light guide portion 14. The light guide portion 14 includes a light guide surface 15 perpendicular to the first flat surface 11 and the second flat surface 12, and has an area greater than an area of the light incident surface 13. Thus, the incident amount of the light 50 is increased. Further, the incident light 50 is less likely to irradiate upon the corners 16 of the light guide surface 15, so that the possibility of reflection of the light 50 is reduced to increase light guide efficiency. Further, step S2 may be directly performed, through which the formation of sharp corners can be directly reduced by a gathering effect of molecules of the glass in a molten state.

In step S4, a mirror process is performed on the light guide surface 15. For example, a polishing process is performed on the light guide surface 15, such that a surface roughness (Ra) of the light guide surface 15 is smaller than 0.2 μm to reduce the level of scattering of the light 50.

In step S5, a plurality of light guide micro structures 30 are formed on the second flat surface 12. These light guide micro structures 30 reflect the light 50 to the first flat surface 11, and the light 50 then emits from the first flat surface 11.

One difference of this embodiment from the foregoing embodiments is that, the shape of the thermoplastic machine 20 is not limited. Therefore, to adapt to user requirements, the light guide portion 14 may be formed into different shapes.

In conclusion, the present invention provides following features.

1. The area of the light guide plate is greater than the area of the light incident surface. Thus, the incident amount of light is increased. Further, the incident light is less likely to irradiate upon the corners of the light guide surface, so that the possibility of reflection of the light is reduced to increase light guide efficiency.

2. By performing the mirror process on the light guide surface, the level of scattering of the light can be reduced to increase the light entering the glass plate.

3. Through the method for manufacturing the light guide portion by heating and extruding using the thermoplastic machine, the light guide portion is formed as an integral on the glass plate, thereby preventing an issue of brightness loss due light reflection caused by additionally manufactured light guide elements.

4. With the light guide micro structures disposed, the light is allowed to emit via the first flat surface to form a uniform plane light source.

5. As the glass plate is heat resistant, the light source may be adhered on the light guide surface without incurring the issue of overheating and melting a plastic material as in the prior art.

What is claimed is:

1. A method for manufacturing a glass light guide plate having high transmission efficiency, comprising steps of:
S1: cutting and forming a glass plate using a cutter machine, the glass plate comprising a first flat surface and a second flat surface that are opposite and parallel to each other, and a light incident surface perpendicular and connected to the first flat surface and the second flat surface; and
S2: heating and extruding the light incident surface using a thermoplastic machine to deform the light incident surface to form a light guide portion, the light guide portion comprising a light guide surface perpendicular to the first flat surface and the second flat surface and having an area greater than an area of the light incident surface.

2. The method for manufacturing a glass light guide plate having high transmission efficiency of claim 1, between step S1 and step S2, further comprising a step of:
S1A: performing a rounding process on a plurality of corners of the glass plate.

3. The method for manufacturing a glass light guide plate having high transmission efficiency of claim 2, wherein in step S1A, the rounding process on the corners is performed by one of a computer numerically-controlled (CNC) tool machine or chemical grinding.

4. The method for manufacturing a glass light guide plate having high transmission efficiency of claim 1, wherein step S2 further comprises steps of:
S2A: aligning the light incident surface of the glass plate with a wedged heating module of the thermoplastic machine; and
S2B: thrusting the wedged heating module by a thrusting module of the thermoplastic machine to extrude the light incident surface of the glass plate to form the light guide portion.

5. The method for manufacturing a glass light guide plate having high transmission efficiency of claim 4, after step S2, further comprising a step of:
S3: performing a mirror process on the light guide surface to reduce a level of scattering of light.

6. The method for manufacturing a glass light guide plate having high transmission efficiency of claim 1, after step S2, further comprising a step of:
S4: performing a mirror process on the light guide surface to reduce a level of scattering of light.

7. The method for manufacturing a glass light guide plate having high transmission efficiency of claim 1, after step S2, further comprising a step of:
S5: forming a plurality of light guide micro structures on the second flat surface.

8. The method for manufacturing a glass light guide plate having high transmission efficiency of claim 7, wherein in step S5, a distribution density of the light guide micro structures adjacent to the light guide portion is lower than a distribution density of the light guide micro structures away from the light guide portion.

9. The method for manufacturing a glass light guide plate having high transmission efficiency of claim 7, wherein in step S5, a shape of the light guide micro structures is selected from a group consisting of a semi-sphere and a pyramid.
